(19) United States
(12) Patent Application Publication
(10) Pub. No.: US 2026/0330040 A1
(43) Pub. Date: Oct. 22, 2026

(54) AUTOMATED SECURITY POLICY RULE GENERATION FOR API RESPONSE FIELDS

(71) Applicant: Palo Alto Networks, Inc., Santa Clara, CA (US)

(72) Inventors: Venkatesh Kumaran Pappakrishnan, Dublin, CA (US); Alok Tongaonkar, San Jose, CA (US)

(21) Appl. No.: 19/182,068

(22) Filed: Apr. 17, 2025

(51) Int. Cl. G06F 21/60

(52) U.S. Cl. CPC G06F 21/604

(57) ABSTRACT

An API documentation manager identifies functions of a vendor's API indicated in published documentation, determines those for which a security policy rule has not been created, and designates the determined function(s) for further evaluation by a security policy rule generator (“rule generator”). The rule generator determines if each designated function comprises a response field related to security based on its description in the documentation. If the function comprises a security related response field, the rule generator predicts a possible value of the response field that is indicative of a security issue. The rule generator generates a query language rule for performing checks of the response field for the determined value and converts the query language rule into a security policy rule formatted for deployment to detect security issues based on evaluation of response fields. The rule generator leverages a language model(s) and few-shot prompting for these tasks.

### BACKGROUND

The disclosure generally relates to data processing (e.g., CPC subclass G06F) and to computing arrangements based on specific computational models (e.g., CPC subclass G06N).

Cloud service providers (CSPs) are providers of cloud computing technology that deliver computing resources in the cloud. With cloud computing, applications and other computing resources traditionally hosted on-premises are delivered by a CSP over the Internet. CSPs offer Anything-as-a-Service (XaaS) solutions, such as Infrastructure-as-a-Service (IaaS), Platform-as-a-Service (PaaS), and Software-as-a-Service (SaaS), which provide cloud-based infrastructure, cloud-based platforms, and cloud-based applications, respectively. A variety of vendors of hardware technology and software technology employ the services of CSPs for hosting technology in the cloud instead of or in addition to on-premises as hardware and software have traditionally been delivered. End users of a CSP, including such vendors of cloud-delivered technology, can interact with the CSP via application programming interfaces (APIs) of the CSP. Cloud APIs provide an interface for managing computing resources or utilizing the services of a CSP. To inform end users of the available functionality of the CSP that can be invoked via the cloud API exposed by the CSP, the CSP provides documentation for the cloud API that indicates functions of the cloud API, the associated request and response parameters, and any corresponding descriptions.

Rapid developments in artificial intelligence (AI) technologies have spawned numerous terms with fluid meanings. Recently, AI technologies are frequently referred to with the terms large language model (LLM), generative AI, and foundation model. Many of these technologies are based on or relate to the “Transformer” architecture. A “Transformer” was introduced in VASWANI, et al. “Attention is all you need” presented in Proceedings of the 31st International Conference on Neural Information Processing Systems in December 2017, pages 6000-6010. The Transformer is a first sequence transduction model that relies on attention and eschews recurrent and convolutional layers. The Transformer architecture has been referred to as a “foundational model.” The Center for Research on Foundation Models at the Stanford Institute for Human-Centered Artificial Intelligence used this term in an article “On the Opportunities and Risks of Foundation Models” to describe a model trained on broad data at scale that is adaptable to a wide range of downstream tasks. There has been subsequent research in similar Transformer-based sequence modeling. The architecture of a Transformer model typically is a neural network with transformer blocks/layers, which include self-attention layers, feed-forward layers, and normalization layers. The Transformer model learns context and meaning by tracking relationships in sequential data. Some LLMs are based on the Transformer architecture. An LLM is “large” because the training parameters are typically in the billions and have been approaching a trillion parameters. AI technologies are not limited to LLMs and research and utilization of “lightweight” language models (i.e., fewer parameters than large) has grown. Language models can be pre-trained to perform general-purpose tasks or tailored to perform specific tasks.

### BRIEF DESCRIPTION OF THE DRAWINGS

Embodiments of the disclosure may be better understood by referencing the accompanying drawings.

FIG. 1 is a conceptual diagram of automated generation of security policy rules for API functions based on API documentation published by a vendor.

FIG. 2 is a flowchart of example operations for identifying API functions to be evaluated for security policy rule creation.

FIG. 3 is a flowchart of example operations for evaluating an API function for security policy rule creation.

FIG. 4 is a flowchart of example operations for generating a security policy rule for an API response field.

FIG. 5 depicts an example computer system with an API documentation manager and an API security policy rule generator.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

As vendors such as cloud service providers (CSPs) publish new APIs, cybersecurity organizations are often tasked with generating security policies for API functions that access sensitive data or services of the vendor. This can be laborious and time consuming due to the technical expertise relied upon for security policy creation. Security policy creation for API functions offered by a vendor (e.g., a CSP) that is automated end-to-end is disclosed herein. This approach provides zero-day support for new API functions determined to be security related and reduces the time elapsed from API publication to security policy availability for new or updated API functions.

An API documentation crawler crawls API documentation repositories for supported vendors and, as new APIs or updates to existing APIs are detected, retrieves the corresponding documentation for an API documentation manager. The API documentation manager determines if the existing security policies cover the function(s) of the new/updated API. If the existing security policies do not cover a function(s) of the new or updated API, such as if the API includes a new function or adds a new response field for an existing function, the API documentation manager indicates that the API function(s) should be evaluated for security policy generation.

For each API function indicated for evaluation, a security policy rule generator (“rule generator”) determines if the function comprises at least one response field that is related to security based on its description identified in the API documentation. If the function comprises a response field that is related to security, the rule generator determines at least a first value of possible values of the security-related response field that is predicted to be indicative of a security issue. Security issues can include misconfigurations of resources in the vendor's environment (e.g., cloud resources) or vulnerabilities, both of which are detectable based on the API response field having the determined value. The rule generator can generate and validate a query language rule for identifying security issues based on evaluation of API responses for the function, where the query language rule indicates the response field related to security and the determined value. From the validated query language rule, the rule generator generates a security policy rule in a designated format, such as a JavaScript® Object Notation (JSON) or YAML Ain′t Markup Language (YAML) formatted file, that can be deployed for detecting security issues based on evaluation of API response fields. The rule generator leverages a language model(s) and few-shot prompting for each of these tasks through construction of prompts that are submitted to the language model(s). Leveraging few-shot prompting reduces the quantity of examples that are needed for completion of each task relative to other machine-learning based techniques (e.g., training of a classifier(s)).

### Example Illustrations

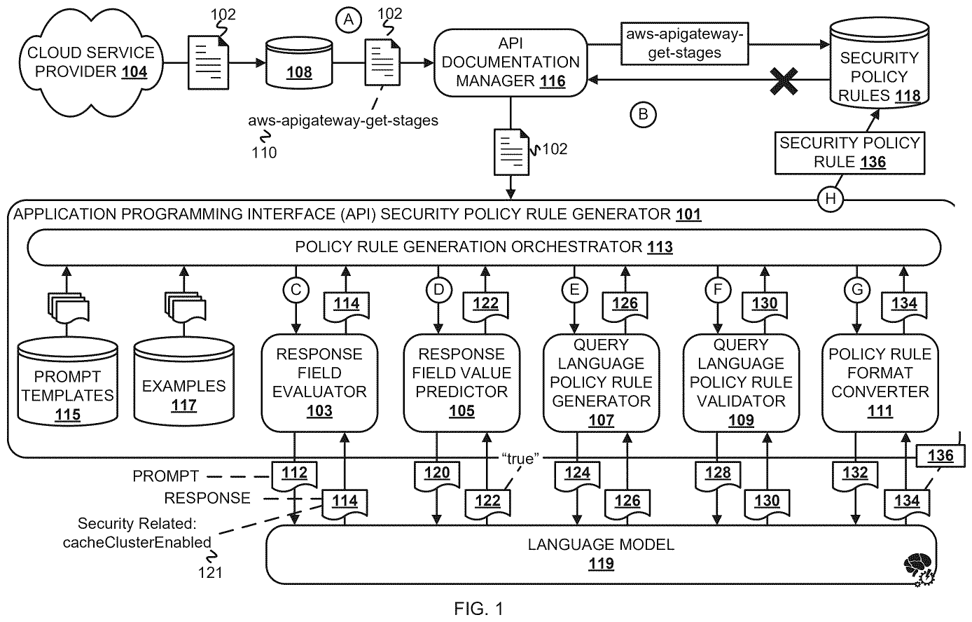

FIG. 1 is a conceptual diagram of automated generation of security policy rules for API functions based on API documentation published by a vendor. In this example, the vendor is a CSP 104 that has published API documentation 102. For instance, the API documentation 102 can comprise documentation for an API of each of one or more services offered by the CSP 104. The API documentation 102 indicates one or more API functions, request and response formats for each function, and corresponding descriptions. This example assumes that the CSP 104 maintains a repository 108 for published API documentation such as the API documentation 102.

FIG. 1 depicts an API documentation manager (“documentation manager”) 116 and an API security policy rule generator (“rule generator”) 101. The API documentation manager 116 identifies new (e.g., newly published and/or updated) API documentation published by the CSP 104 and processes the published documentation to determine if any API functions indicated therein should be evaluated further by the rule generator 101. The rule generator 101 evaluates documentation of API functions to determine whether a response field of an API function described in the corresponding documentation is related to security. If such a response field is identified, the rule generator 101 determines which of a set of possible values of that field are predicted to be indicative of a security issue and generates a security policy rule for identifying security issues in a deployment environment (e.g., an environment of an application that interfaces with the CSP 104 via its API) based on evaluation of the API response for that function. Security issues detectable via API response fields include misconfigured resources, vulnerabilities, and the like.

The rule generator 101 comprises a policy rule generation orchestrator (“orchestrator”) 113, a response field evaluator 103, a response field value predictor (“value predictor”) 105, a query language policy rule generator (“query rule generator”) 107, a query language policy rule validator (“rule validator”) 109, and a policy rule format converter (“format converter”) 111. The orchestrator 113 orchestrates a plurality of stages of security policy rule creation performed by respective ones of the response field evaluator 103, value predictor 105, query rule generator 107, rule validator 109, and format converter 111. The orchestrator 113 also has access to a prompt template database 115, which stores a plurality of prompt templates, and examples database 117, which stores examples created for few-shot prompting. For instance, at each stage described below performed by the rule generator 101, the orchestrator 113 can retrieve a corresponding prompt template and examples from the prompt template database 115 and example database 117, respectively, and provide the prompt template and examples to a corresponding one of the other components of the rule generator 101 for population of the prompt template and prompting as is described below.

FIG. 1 is annotated with a series of letters A-H. Each letter corresponds to a stage of one or more operations. Although these stages are ordered for this example, the stages illustrate one example to aid in understanding this disclosure and should not be used to limit the claims. Subject matter falling within the scope of the claims can vary from what is illustrated.

At stage A, the documentation manager 116 retrieves the API documentation 102 from the repository 108. For instance, a crawler may be deployed for monitoring additions and/or updates to documentation stored in the repository 108, where the crawler identifies the API documentation 102 as newly published, retrieves the documentation from the repository 108, and communicates the API documentation 102 to the documentation manager 116. The API documentation 102 in this example comprises documentation for a function 110 named “aws-apigateway-get-stages” offered by the Amazon Web Services® (AWS) CSP. The documentation manager 116 parses the API documentation 102 so that individual function names, response fields, etc. are accessible therein. To illustrate, if the API documentation 102 is formatted with JSON, the documentation manager 116 parses the API documentation 102 to generate a corresponding JavaScript object.

At stage B, the documentation manager 116 determines if a security policy rule has already been created for the function 110. Security policy rules created for API functions are implemented to perform checks on API responses for applications, services, etc. that invoke functionality of the CSP 104 via its API, where certain values of API response fields of a plurality of functions have been previously determined to be indicative of a security issue (e.g., a security issue affecting a cloud resource accessed via a corresponding API function). The documentation manager 116 queries a database 118 that maintains security policy rules to determine whether a security policy rule has been created for the function 110. The database 118 may store, for each security policy rule, a hash of the associated API response based on which the rule was created. In this case, the documentation manager 116 hashes the API response corresponding to the function 110 extracted from the API documentation 102 and queries the database 118 with the hash value. This example assumes that there is no matching value found in the database 118, so the documentation manager 116 provides the API documentation 102 to the rule generator 101 for further evaluation.

At stage C, the response field evaluator 103 determines if the API documentation 102 of the function 110 comprises a response field that is related to security. The response field evaluator 103 generates a prompt 112 (e.g., based on a corresponding prompt template retrieved from the prompt template database 115 and examples retrieved from the examples database 117) that comprises at least a subset of the API documentation 102 that includes the field(s) defined for an API response for the function 110 and description(s) thereof, one or more examples of security related and/or security unrelated API response fields, and a task instruction to determine if any of the API response fields are related to security. An example prompt template that the response field evaluator 103 can populate to generate the prompt 112 is as follows:

{
You are a cloud security expert knowledgeable on the APIs released by cloud service
providers and the corresponding API response fields. Your task is to classify the API
response fields that may be security sensitive based on the field descriptions.
Here is a set of example evaluations:
< Include few shot samples here:
Field Descriptions: Whether the task's elastic network interface receives a public IP
address. The default value is DISABLED.
Output: SECURITY SENSITIVE
Field Description: Contains additional information about the error. If the value or Error is
null the value of ErrorMessage also is null.
Output: NOT SECURITY SENSITIVE
... <more few shots if needed>
>
Your goal is to understand the field descriptions and classify the API response field(s) as
security sensitive or not.
Field Description: <input>
Output:
}

The response field evaluator 103 submits the prompt 112 to a language model 119, such as an instance of an LLM that is publicly available or accessible. The language model 119 generates a response 114, which the response field evaluator 103 provides to the orchestrator 113. The orchestrator 113 evaluates the response 114 to determine if any of the API response fields of the function 110 are related to security. This example assumes that the response 114 indicates that a response field 121 named “cacheClusterEnabled” is determined to be related to security. The orchestrator 113 thus extracts (e.g., copies) the indicated response field from the response 114.

At stage D, the value predictor 105 predicts which of a set of possible values of the response field 121 is potentially indicative of a security issue. The value predictor 105 generates a prompt 120 (e.g., based on a corresponding prompt template retrieved from the prompt template database 115 and examples retrieved from the examples database 117) that indicates the response field 121, the set of possible values of the response field 121, and examples of values of API response fields that are indicative and/or not indicative of a security issue. An example prompt template that the value predictor 105 can populate to generate the prompt 120 is as follows:

```
{
You are a cloud security expert knowledgeable on the APIs released by cloud service
providers such as AWS and the response fields of the APIs. Your task is to identify the
values of a field in the API response that are security sensitive.
Here is a set of example evaluations:
< Include few shot samples here:
API call: aws apigateway get-stages --rest-api-id 1234123412
API Response: {
  “item”: [
    {
      “stageName”: “dev”,
      “cacheClusterSize”: “0.5”,
      “cacheClusterEnabled”: true,
      “cacheClusterStatus”: “AVAILABLE”,
      “deploymentId”: “123h64”,
      “lastUpdatedDate”: 1456185138,
      “createdDate”: 1453589092,
      “methodSettings”: {
        “~1resource~1subresource/POST”: {
          “cacheTtlInSeconds”: 300,
          “loggingLevel”: “INFO”,
          ...
        }
      }
    }
  ] ... }
Output: “cacheClusterEnabled”: true
... <more few shots if needed>
>
Your goal is to understand the different API response fields and possible values then
identify the field that is security sensitive and its value.
API function: <input>
API response: <input>
Output:
}
```

The value predictor 105 submits the prompt 120 to the language model 119. The language model 119 generates a response 122, which the value predictor 105 provides to the orchestrator 113. The orchestrator 113 evaluates the response 122 to determine the value of the response field 121 that is predicted to be indicative of a security issue. In this example, the response 122 may indicate that a security issue is potentially present if the response field 121 is identified to have a value of “true.”

At stage E, the query rule generator 107 generates a rule written in a query language for checking if the value of the response field 121 is the value identified by the value predictor 105 (e.g., the value “true”). The query rule generator 107 generates a prompt 124 (e.g., based on a corresponding prompt template retrieved from the prompt template database 115 and examples retrieved from the examples database 117) that indicates the response field 121 and value of “true,” examples of API response fields, security sensitive values, and corresponding rules written in the query language for performing checks on those API response fields, and a task instruction to generate a rule written in the query language for the provided API response field and value. Implementations can use standard query languages for generating the query language rule or a proprietary query language, such as a query language defined by a cybersecurity vendor with which the rule generator 101 is associated. In the latter case, the prompt 124 may also comprise a description of the proprietary query language, such as a grammar of the query language. An example prompt template that the query rule generator 107 can populate to generate the prompt 124 is as follows, where implementations can specify a particular proprietary query language in place of the placeholder depicted in this example:

```
{
You are an expert in the <proprietary query language>. You are familiar with different
types of <proprietary query language>, its grammar, and possible fields it can take.
Different types of <proprietary query language> are:
  1. Config
  2. Event, and
  3. Network
The <proprietary query language> language follows the grammar provided here:
<Include grammar for the proprietary query language here>
Here is a set of example query language rules for different API response fields and their
values:
< Include few shot samples here>
Field Descriptions: Whether the task's elastic network interface receives a public IP
address. The default value is DISABLED.
API call: aws apigateway get-stages --rest-api-id 1234123412
API sensitive field: “cacheClusterEnabled”: true
Query language rule: “config from cloud.resource where cloud.type = ‘aws' AND
api.name = ‘aws-apigateway-get-stages' AND json.rule = webAclArn does not exist or
webAclArn does not start with arn:aws:wafv2”
... <more few shots if needed>
<end of few shots>
Your goal is to generate a <proprietary query language> rule to detect resources that are
affected by a security issue using the API description, fields, values, <proprietary query
language> grammar, and the few shot examples.
Field Descriptions: <input>
API call: <input>
API sensitive field: <input>
Query language rule: <output>
}
```

The query rule generator 107 submits the prompt 124 to the language model 119. The language model 119 generates a response 126, which the query rule generator 107 provides to the orchestrator 113. The response 126 comprises a rule written in the query language specified in the prompt 124 for the API response field and corresponding value “cacheClusterEnabled” and “true.” The orchestrator 113 identifies in the response 126 the query language rule generated for the API response field “cacheClusterEnabled” and corresponding value of “true” and extracts the query language rule from the response 126.

At stage F, the rule validator 109 validates the query language rule generated by the language model 119 at stage E. The rule validator 109 generates a prompt 128 (e.g., based on a corresponding prompt template retrieved from the prompt template database 115 and examples retrieved from the examples database 117) that indicates the query language rule, examples of valid and/or invalid rules written in the query language, and a task instruction to determine if the query language rule is valid. The prompt 128 can further include an instruction to rewrite the provided query language rule such that the rule is valid if the provided rule is not valid as originally written. An example prompt template that the rule validator 109 can populate to generate the prompt 128 is as follows, where implementations can specify the particular proprietary query language used to generate the query language rule in place of the placeholder depicted in this example:

{
You are an expert in <proprietary query language>. You are familiar with different types
of <proprietary query language>, its grammar, and possible fields it can take.
Your task is to validate the <proprietary query language> rule provided for the given API
field description and values. If the <proprietary query language> rule generated is
inaccurate, generate a new one.
The <proprietary query language> follows the grammar provided here:
<Include grammar for the proprietary query language here>
Here is a set of <proprietary query language> rules along with their API details and
values:
< Include few shot samples here>
Field Descriptions: Whether the task's elastic network interface receives a public IP
address. The default value is DISABLED.
API call: aws apigateway get-stages --rest-api-id 1234123412
API sensitive field/value: ″cacheClusterEnabled″: true
Query language rule: ″config from cloud.resource where cloud.type = ′aws′ AND
api.name = ‘aws-apigateway-get-stages' AND json.rule = webAclArn does not exist or
webAclArn does not start with arn:aws:wafv2″
Output: {Result: “Valid”, Query language rule: “”}
Field Descriptions: Whether the task's elastic network interface receives a public IP
address. The default value is DISABLED.
API call: aws apigateway get-stages -- rest-api-id 1234123412
API sensitive field/value: ″cacheClusterEnabled″: true
Query language rule: ″config from cloud.resource where cloud.type = ′aws′ AND
api.name = ′aws-apigateway-get-stages′ AND json.rule = webAclArn does not exist or
webAclArn does not start with arn:aws:wafv2″
Output: {Result: “Invalid”, Query language rule: “config from ... ”}
... <more few shots if needed>
<end of few shots>
Your goal is to validate the <proprietary query language> rule and, if invalid, generate a
new one.
Field Descriptions: <input>
API call: <input>
API sensitive field:
Query language rule: <input>
Output:
}

The rule validator 109 submits the prompt 128 to the language model 119. The language model 119 generates a response 130, which the rule validator 109 provides to the orchestrator 113. The response 130 indicates if the original query language rule was valid and, if the query language rule was not valid, includes a valid representation of the query language rule. The orchestrator 113 identifies the valid query language rule in the response 130 and extracts the rule from the response 130.

At stage G, the format converter 111 converts the query language rule to a format used for security policy rules to be enforced. Security policy rules to be enforced can be formatted with JSON, YAML, or another data serialization language. The format converter 111 generates a prompt 132 (e.g., based on a corresponding prompt template retrieved from the prompt template database 115 and examples retrieved from the examples database 117) that indicates the query language rule, an indication of a format to which the query language rule should be converted, example pairs of query language rules and corresponding rules formatted according to the designated format, and a task instruction to rewrite the query language rule to a rule in the designated format. An example prompt template that the format converter 111 can populate to generate the prompt 132 is as follows, where implementations can again specify the proprietary query language in place of the placeholder depicted in this example:

{
You are an expert in <proprietary query language>. You are familiar with different types
of <proprietary query language>, its grammar, and possible fields it can take. You are
skilled at converting <proprietary query language> into YAML or JSON format as
requested.
Your task is to convert the <proprietary query language> rule into YAML or JSON
format as per the request.
Here are some examples:
< Include few shot samples here>
<proprietary query language> : <sample query language rule>
Format: YAML
YAML: <YAML output>
<proprietary query language>: <sample query language rule>
Format: JSON
JSON: <JSON output>
<end of few shots>
Your goal is to accurately generate a YAML or JSON formatted rule from the
<proprietary query language> rule provided.
<proprietary query language>: <input query language rule>
Format: <intended format>
<output>
}

The format converter 111 submits the prompt 132 to the language model 119. The language model 119 generates a response 134, which the format converter 111 provides to the orchestrator 113. The response 134 indicates a security policy rule 136 formatted according to the format indicated in the prompt 132. The orchestrator 113 identifies the security policy rule 136 in the response 134 and extracts the security policy rule 136 from the response 134.

At stage H, the rule generator 101 stores the security policy rule 136 in the database 118. The rule generator 101 stores the security policy rule 136 in the database 118 for subsequent enforcement of the security policy rule 136, which identifies API responses for the function 110 for which the value of the field “cacheClusterEnabled” is “true.” The rule generator 101 can also generate a hash value of the API response for the function 110 and store the generated hash value in association with the security policy rule 136 so that subsequent lookups in the database 118 for a hash of the API response field for the function 110 will yield a determination that a security policy rule has already been created for the function 110.

FIG. 1 depicts the components of the rule generator 101 prompting a language model 119. Implementations can leverage a plurality of language models instead of one language model. For instance, the response field evaluator 103 can prompt a first language model, the value predictor 105 can prompt a second language model, and so on. The language models can be different instances of a same language model (e.g., different instances of a same LLM) or can correspond to two or more different language models. The language models can further be fine-tuned, prompt-tuned, or otherwise adapted for a specific task indicated in prompts submitted by the corresponding one of the components of the rule generator 101.

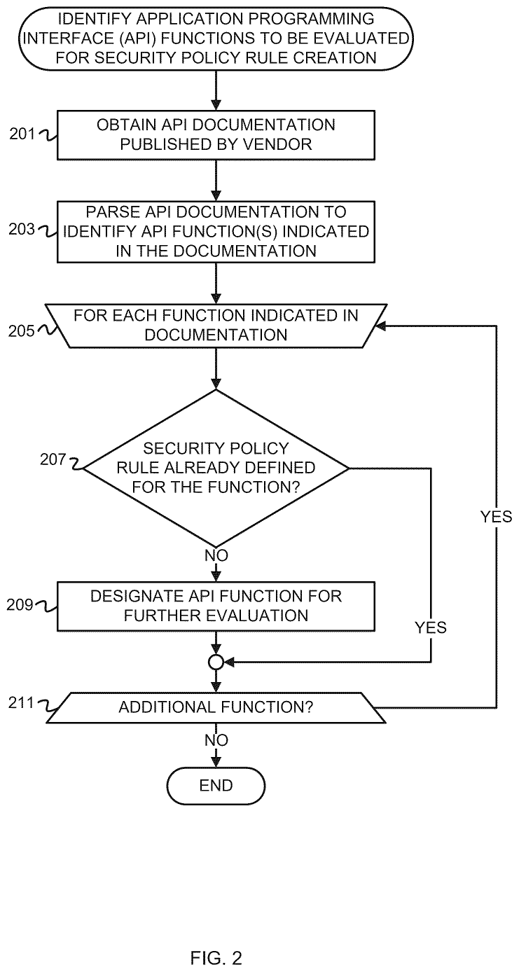

FIGS. 2-4 are flowcharts of example operations. The example operations are described with reference to an API documentation manager and an API security policy rule generator (hereinafter “the rule generator” for brevity) for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for identifying API functions to be evaluated for security policy rule creation. The example operations are described with reference to the API documentation manager.

At block 201, the API documentation manager obtains API documentation published by a vendor. The API documentation manager may obtain the API documentation from a crawler that crawls an API documentation repository (ies) managed by the vendor and identifies new (e.g., newly published, updated, etc.) API documentation.

At block 203, the API documentation manager parses the API documentation to identify one or more API functions indicated therein. The API documentation manager parses the API documentation so that individual function names, field names, etc. indicated in the documentation can be accessed.

At block 205, the API documentation manager begins iterating over API functions indicated in the documentation. The documentation indicates names of one or more functions and, for each function, request and response fields and their corresponding descriptions.

At block 207, the API documentation manager determines if a security policy rule has already been defined for the function. The API documentation manager maintains or has access to a data store (e.g., a database, a data structure(s), etc.) that maintains indications of API functions for which security policy rules have been defined. For instance, the API documentation manager can maintain or have access to a data store (e.g., a hash table or database) that comprises hashes generated from documentation of API functions for which a corresponding security policy rule has been defined. As security policy rules for API functions are generated, hashes of the corresponding API response extracted from the description are generated with a hash function and stored in the data store. The documentation that is hashed can include names of the API function and API response field(s) such that changes to response fields of the API function can be identified from comparison of hash values generated from API function documentation. The API documentation manager can compute a hash value based on the API documentation using a hash function that was used to generate the hashes maintained in the data store, such as a hash function from the Secure Hash Algorithm (SHA) family, the MD5 message-digest algorithm, etc. In this case, the API documentation manager determines if a security policy rule has already been defined for the function based on whether a hash computed from the API function documentation matches one that is already stored. If a security policy rule has not yet been defined for the function, operations continue at block 209. If a security policy rule has already been defined for the function, operations continue at block 211.

At block 209, the API documentation manager designates the API function for further evaluation. The API documentation manager provides the documentation of the API function to the rule generator for further evaluation to determine if a security policy rule should be generated for the API function.

At block 211, the API documentation manager determines if there was an additional function of the API indicated in the documentation. If there is an additional API function, operations continue at block 205. If not, operations are complete.

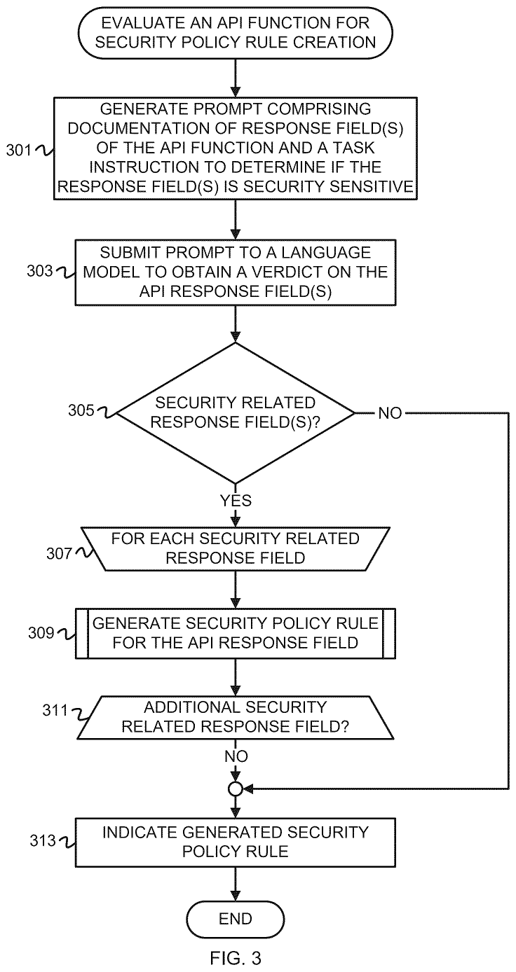

FIG. 3 is a flowchart of example operations for evaluating an API function for security policy rule creation. The example operations are described with reference to the rule generator. The example operations assume that the rule generator has obtained documentation of an API function published by a vendor, which at least includes a name of the function, indications of one or more response fields defined for the function, and a description of each API response field.

At block 301, the rule generator generates a prompt comprising documentation of one or more response fields of the API function and a task instruction to determine if any response field of the API function is related to security. The documentation of the response field(s) of the API function comprises a name and description of each response field defined for the API function. A response field is related to security if the field relates to data/metadata, functionality of the vendor, etc. that has implications for security, such as if the response field indicates a configuration setting of a resource that can be evaluated for the presence of a misconfiguration. The rule generator has been configured with or retrieves (e.g., from a prompt template repository) a prompt template that comprises placeholders for response field descriptions and a task instruction to identify any response field that is related to security, to classify the response fields as security related or security unrelated, or similar. The prompt template also includes or can be populated with one or more examples of API response fields, their descriptions, and indications of whether or not each API response field is related to security. For instance, the rule generator can retrieve the one or more examples from a database of examples created for few-shot prompting.

At block 303, the rule generator submits the prompt to a language model to obtain a verdict on the API response field(s). The language model can be an LLM. The rule generator submits the prompt to the language model to obtain a response generated by the language model that indicates whether the API response field(s) is related to security.

At block 305, the rule generator determines if the API response includes at least a first security related response field. The rule generator determines if the response obtained from the language model indicates that one or more fields of the API response are related to security. If the API response comprises a security related response field(s), operations continue at block 307. If not, operations are complete, and no security policy rule is created for the function because none of its response fields are relevant to security.

At block 307, the rule generator begins iterating over security related response fields of the API response. An API response will often have at most one field that is security related, though API responses may have multiple security related fields.

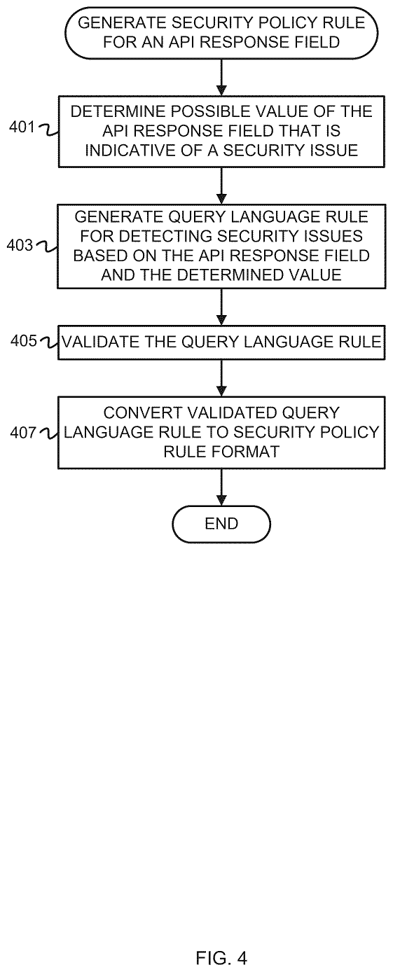

At block 309, the rule generator generates a security policy rule for the API response field. The rule generator predicts a value of the response field that is indicative of a security issue. Based on determining a value of the response field indicative of a security issue, the rule generator creates a security policy rule for evaluation of API responses obtained from invocation of the function to determine if the security related response field comprises the value determined to be indicative of a security issue. Generation of a security policy rule for the API response field is described in further detail in reference to FIG. 4.

At block 311, the rule generator determines if there is an additional security related response field for the API response. If so, operations continue at block 307. If not, operations continue at block 313.

At block 313, the rule generator indicates the generated security policy rule. The rule generator can store the generated security policy rule in a data store maintained for security policy rules, indicate the generated security policy rule in a notification or report, etc. The security policy rule ultimately generated is thus deployed for enforcement. The rule generator can also generate a hash of the API response based on which the security policy rule was generated and store the hash in a data store in association with the security policy rule and/or an indication of the corresponding API function to facilitate subsequent determination of whether a security policy rule has been created for the API function.

In FIG. 3, the example operations describe the rule generator as generating a single prompt indicating each API response field and corresponding description documented for an API function. Implementations can generate individual prompts for API functions having multiple response fields indicated in their documentation, with each prompt comprising a description of a corresponding one of the response fields, and submit each prompt to the language model.

FIG. 4 is a flowchart of example operations for generating a security policy rule for an API response field. The example operations are described with reference to the rule generator. The rule generator generates a plurality of prompts to a language model (e.g., an LLM) for performing various tasks. The rule generator can interface with one language model to which it submits each prompt or multiple language models to which it submits the prompts, such as one language model per prompt.

At block 401, the rule generator determines a possible value of the API response field that is indicative of a security issue. The rule generator is configured with or retrieves (e.g., from a prompt template database) a prompt template for this task that it populates with at least the API response field. The prompt template may include at least a portion of the documentation of the API function and/or examples of API responses and indications of the security related field and a value of the field that is indicative of a security issue. The rule generator may instead retrieve the examples (e.g., from a database that stores examples generated for few-shot prompting) and populate the prompt template with the examples. The rule generator populates the prompt template to generate a prompt and submits the prompt to a language model. A response obtained from the language model indicates the value of the API response field that is indicative of a security issue.

At block 403, the rule generator generates a query language rule for detecting security issues based on the API response field and the determined value. The query language rule can be a rule written in a standard query language, such as Structured Query Language (SQL), or a proprietary query language. For example, the security vendor that offers the rule generator can define a proprietary query language used for writing rules recognized by components/services of the security vendor. The rule generator retrieves or is configured with a prompt template for generation of query language rules based on API response fields and corresponding values determined to be informative to identifying security issues. The prompt template can comprise placeholders for the API response field, the value determined to be informative to identifying security issues, and examples of rules written in the query language for a corresponding API response field and value. In other examples, the rule generator can retrieve the examples and populate the prompt template with the examples. The rule generator populates the prompt template to generate a prompt and submits the prompt to a language model. A response obtained from the language model indicates the query language rule generated for the API response field and determined value.

At block 405, the rule generator validates the query language rule. The rule generator validates the query language rule to ensure it comports to the grammar of the query language in which it is written and will not produce errors if enforced. The rule generator retrieves or is configured with a prompt template for validating query language rules generated for API response fields and values. The prompt template can comprise a placeholder for the query language rule generated at block 403, information about the query language to inform validation, and examples of valid and/or invalid query language rules. In other examples, the rule generator can retrieve the examples and populate the prompt template with the examples. The rule generator populates the prompt template to generate a prompt and submits the prompt to a language model. A response obtained from the language model indicates whether the query language rule is valid or invalid. If the query language rule as originally written was invalid, the response should indicate a new version of the query language rule rewritten to be valid. Subsequent operations assume that the query language rule that results after prompting the language model is valid. In implementations, however, if a valid query language rule is not ultimately generated (e.g., if the language model produces an error message), the API response field, determined value, and the invalid query language rule can be designated for further analysis, such as in a report, notification, etc. produced for expert review.

At block 407, the rule generator converts the validated query language rule to a security policy rule format. Security policy rules can be formatted with JSON, YAML, or another data serialization language (which may be a standard/recognized data serialization language or a proprietary data serialization language). The rule generator generates a prompt for converting a query language rule to a different format to be used for generated security policy rules and submits the prompt to a language model. The rule generator can be configured with or can retrieve a prompt template that comprises an indication of the format to be used for the generated security policy rule, a placeholder for the query language rule, and one or more examples of pairs of query language rules and corresponding security policy rules in the designated format. In other examples, the rule generator can retrieve the examples and populate the prompt template with the examples. The rule generator generates the prompt by populating the prompt template and submits the prompt to a language model. A response from the language model indicates a security policy rule formatted according to the designated format.

The example operations of FIG. 4 describe generating a query language rule for checking a value of an API response field and converting the query language rule to a security policy rule in a designated format for deployment. Implementations can generate a query language rule for checking the value of the API response field as an intermediate step in generating security policy rules comporting to another known format such as JSON or YAML as described in this example. As another example, implementations can instead enforce the query language rules for checking values of API response fields. Further, implementations can also generate a security policy rule in a data serialization directly from the API response field and value determined to be reflective of a security issue (i.e., can skip the generation of the query language rule as an intermediate step). In this case, the prompt generated and submitted to the language model varies from that described above. For instance, the rule generator can use a prompt template that comprises examples of API response fields, corresponding values indicative of a security issue, and the associated security policy rules formatted with JSON, YAML, etc.

### Variations

This description refers to pre-trained language models, such as LLMs, that are prompted to perform various tasks with prompts engineered for those tasks. Implementations can also or instead leverage a pre-trained language model(s) that has been fine-tuned or otherwise adapted for a specific task.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in block 207 of FIG. 2 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

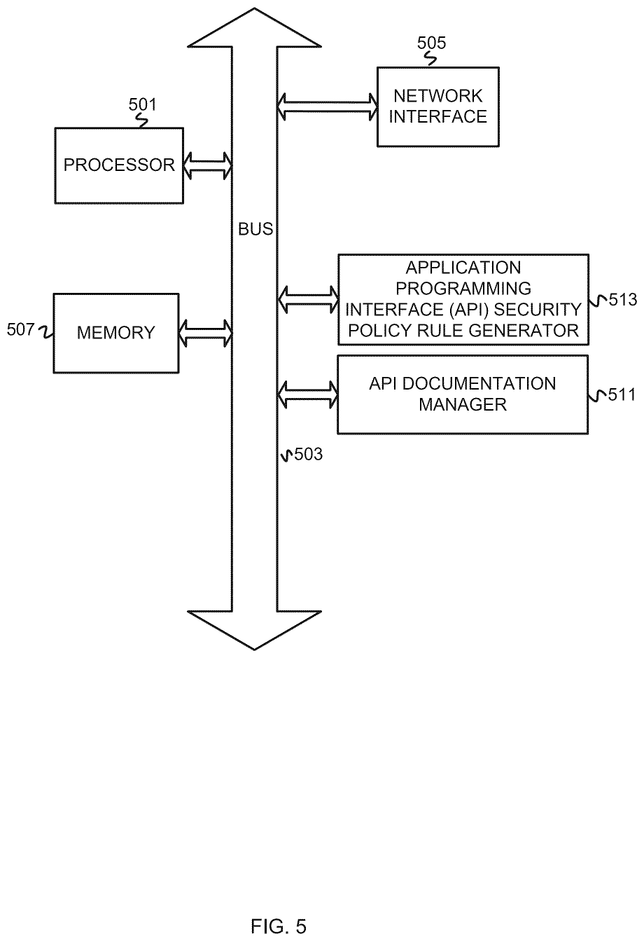

FIG. 5 depicts an example computer system with an API documentation manager and an API security policy rule generator. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes API documentation manager 511 and API security policy rule generator 513. The API documentation manager 511 evaluates API documentation published by a vendor and identifies API functions to be further evaluated for generation of a security policy rule. The API security policy rule generator 513 identifies any API response fields of the functions designated for further evaluation that are related to security and, for those API response fields determined to be security related, generates a security policy rule therefrom. While depicted as part of the same computer system in FIG. 5 in this example, in implementations, the API documentation manager 511 and API security policy rule generator 513 do not necessarily execute as part of the same computer system. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
generating a first security policy rule for a first function of an application programming interface (API), wherein generating the first security policy rule comprises,
retrieving documentation of the first function of the API, wherein the documentation of the first function indicates one or more response fields of the API;
determining if any of the one or more response fields are related to security based on prompting a language model with descriptions of each of the one or more response fields identified in the documentation;
based on determining that a first response field of the one or more response fields is related to security, determining one or more values of a set of possible values of the first response field that are indicative of a security issue based on prompting the language model with the first response field and the set of possible values; and
generating the first security policy rule based on prompting the language model with the first response field and the one or more values of the first response field, wherein the first security policy rule comprises the first response field and the one or more values that are indicative of a security issue.

2. The method of claim 1, wherein determining if any of the one or more response fields are related to security based on prompting the language model comprises,
generating a prompt comprising the one or more response fields, the descriptions of each of the one or more response fields, a first plurality of examples of descriptions of response fields that are related to security, and a second plurality of examples of descriptions of response fields that are not related to security; and
invoking the language model with the prompt, wherein a response from the language model indicates the first response field.

3. The method of claim 1, wherein determining the one or more values that are indicative of a security issue comprises,
generating a prompt comprising the set of possible values of the first response field, an indication of a type of the set of possible values, a first plurality of examples of response fields that are indicative of a security issue, and a second plurality of examples of response fields that are not indicative of a security issue; and
invoking the language model with the prompt, wherein a response from the language model indicates the one or more values.

4. The method of claim 1, wherein generating the first security policy rule based on the first response field and the one or more values of the first response field comprises,
generating a first rule written in a first query language based on the first response field and the one or more values of the first response field; and
generating a data serialization language representation of the first rule, wherein the first security policy rule comprises the data serialization language representation of the first rule.

5. The method of claim 4, wherein generating the first rule comprises,
generating a first prompt comprising the first response field, the one or more values, a plurality of example rules written in the first query language for corresponding ones of a plurality of API response fields and values, and a task instruction to generate a rule written in the first query language based on the first response field, the one or more values, and the plurality of example rules; and
invoking a language model with the first prompt, wherein a response obtained from the language model comprises the first rule.

6. The method of claim 4, wherein generating the data serialization language representation of the first rule comprises,
generating a second prompt comprising the first rule and a plurality of examples of rules written in the first query language and corresponding data serialization language representations; and
invoking a language model with the second prompt, wherein a response obtained from the language model comprises the data serialization language representation of the first rule.

7. The method of claim 4, wherein the data serialization language representation of the first rule comprises a JavaScript Object Notation (JSON) or YAML Ain′t Markup Language (YAML) representation of the first rule.

8. The method of claim 1, further comprising determining if a security policy has already been created for the first function of the API, wherein determining if the first function is associated with sensitive fields is based on determining that a security policy has not already been created for the first function.

9. The method of claim 1, wherein retrieving the documentation of the first function comprises retrieving the documentation published by a cloud service provider (CSP) based on crawling a repository of API documentation published by the CSP.

10. One or more non-transitory machine-readable media having program code stored thereon, the program code comprising instructions to:
retrieve documentation of a first function of an application programming interface (API) published by a vendor, wherein the documentation of the first function indicates one or more response fields of the API;
determine whether any of the one or more response fields are related to security based on prompting a first language model with descriptions of each of the one or more response fields indicated in the documentation;
based on a determination that a first response field of the one or more response fields is related to security, determine one or more values of a set of possible values of the first response field that are indicative of a security issue based on prompting a second language model with the first response field and the set of possible values; and
generate a first security policy rule for the first function of the API based on prompting a third language model with the first response field and the one or more values of the first response field, wherein the first security policy rule comprises the first response field and the one or more values that are indicative of a security issue.

11. The non-transitory machine-readable media of claim 10, wherein the instructions to determine whether any of the one or more response fields are related to security based on prompting the first language model comprise instructions to,
generate a prompt comprising the one or more response fields, the descriptions of each of the one or more response fields, a first plurality of examples of descriptions of response fields that are related to security, and a second plurality of examples of descriptions of response fields that are not related to security; and
submit the prompt to the first language model, wherein a response from the first language model indicates the first response field.

12. The non-transitory machine-readable media of claim 10, wherein the instructions to determine the one or more values that are indicative of a security issue comprise instructions to,
generate a prompt comprising the set of possible values of the first response field, an indication of a type of the set of possible values, a first plurality of examples of response fields that are indicative of a security issue, and a second plurality of examples of response fields that are not indicative of a security issue; and
submit the prompt to the second language model, wherein a response from the language model indicates the one or more values.

13. The non-transitory machine-readable media of claim 10, wherein the instructions to generate the first security policy rule based on the first response field and the one or more values of the first response field comprise instructions to,
generate a first rule written in a first query language based on the first response field and the one or more values of the first response field; and
generate a data serialization language representation of the first rule, wherein the first security policy rule comprises the data serialization language representation of the first rule.

14. The non-transitory machine-readable media of claim 10, wherein the instructions to retrieve the documentation of the first function comprise instructions to retrieve the documentation published by the vendor based on crawling a repository of API documentation published by the vendor.

15. An apparatus comprising:
a processor; and
a machine-readable medium having instructions stored thereon that are executable by the processor to cause the apparatus to,
retrieve documentation of an application programming interface (API) published by a vendor, wherein the documentation indicates one or more functions of the API;
for each of the one or more functions of the API,
determine if any of one or more response fields of the function indicated in the documentation are related to security based on prompting a language model with descriptions of each of the one or more response fields identified in the documentation;
based on a determination that a first response field of the one or more response fields is related to security, determine one or more values of a set of values of the first response field that are indicative of a security issue based on prompting the language model with the first response field and the set of possible values; and
generate a security policy rule based on prompting the language model with the first response field and the one or more possible values of the first response field, wherein the security policy rule comprises the first response field and the one or more values that are indicative of a security issue.

16. The apparatus of claim 15, wherein the instructions executable by the processor to cause the apparatus to determine if any of the one or more response fields are related to security based on prompting the language model comprise instructions executable by the processor to cause the apparatus to,
generate a prompt comprising the one or more response fields, the descriptions of each of the one or more response fields, a first plurality of examples of descriptions of response fields that are related to security, and a second plurality of examples of descriptions of response fields that are not related to security; and
invoke the language model with the prompt, wherein a response from the language model indicates the first response field.

17. The apparatus of claim 15, wherein the instructions executable by the processor to cause the apparatus to determine the one or more values that are indicative of a security issue comprise instructions executable by the processor to cause the apparatus to,
generate a prompt comprising the set of possible values of the first response field, an indication of a type of the set of possible values, a first plurality of examples of response fields that are indicative of a security issue, and a second plurality of examples of response fields that are not indicative of a security issue; and
invoke the language model with the prompt, wherein a response from the language model indicates the one or more values.

18. The apparatus of claim 15, wherein the instructions executable by the processor to cause the apparatus to generate the security policy rule based on the first response field and the one or more values of the first response field comprise instructions executable by the processor to cause the apparatus to,
generate a first rule written in a first query language based on the first response field and the one or more values of the first response field; and
generate a data serialization language representation of the first rule, wherein the security policy rule comprises the data serialization language representation of the first rule.

19. The apparatus of claim 18, wherein the instructions executable by the processor to cause the apparatus to generate the data serialization language representation of the first rule comprise instructions executable by the processor to cause the apparatus to,
generate a prompt comprising the first rule and a plurality of examples of rules written in the first query language and corresponding data serialization language representations; and
invoke the language model with the prompt, wherein a response obtained from the language model comprises the data serialization language representation of the first rule.

20. The apparatus of claim 15, wherein the instructions executable by the processor to cause the apparatus to retrieve the documentation of the API comprise instructions executable by the processor to cause the apparatus to retrieve the documentation based on crawling a repository of API documentation maintained by the vendor.
